(19) United States
(12) Patent Application Publication
(10) Pub. No.: US 2026/0171530 A1
(43) Pub. Date: Jun. 18, 2026

(54) ALUMINIUM COMPOSITE MATERIAL AND PROCESS OF PREPARING THE SAME

(71) Applicant: BASF SE, Ludwigshafen am Rhein (DE)

(72) Inventors: Marc DUCHARDT, Ludwigshafen (DE); Tobias UHLIG, Schwarzheide (DE); Birgit GERKE, Ludwigshafen (DE); Karl HOELEMANN, Ludwigshafen (DE); Wolfgang ROHDE, Ludwigshafen (DE); Regina VOGELSANG, Ludwigshafen (DE); Wolfram WILK, Ludwigshafen (DE); Kerstin SCHIERLE-ARNDT, Ludwigshafen (DE); Nils-Olof Joachim BORN, Ludwigshafen (DE); Andreas Michael KERN, Ludwigshafen (DE); Sven HILDEBRANDT, Muelheim an der Ruhr (DE); Fabian SEELER, Ludwigshafen (DE); Anne-Marie Caroline ZIESCHANG, Ludwigshafen (DE)

(21) Appl. No.: 19/122,770

(22) PCT Filed: Oct. 31, 2023
(86) PCT No.: PCT/EP23/80417

§ 371 Date: Apr. 21, 2025

(30) Foreign Application Priority Data
Nov. 3, 2022 (EP) 22205372.0

(51) Int. Cl. H01M 10/54; C22B 1/02; C22B 1/24; C22B 7/00; H01M 10/0525

(52) U.S. Cl. CPC H01M 10/54; C22B 1/02; C22B 1/24; C22B 7/002; H01M 10/0525

(57) ABSTRACT

Disclosed herein are aluminum composite materials and methods of preparing the same. The aluminum composite materials are useful intermediates in the recycling of lithium ion batteries. For example, some materials may be easily leached to obtain one or more value metals.

### FIELD OF THE INVENTION

Disclosed are aluminum composite materials and methods of preparing the same. The aluminum composite materials are useful intermediates in the recycling of lithium ion batteries. For example, some materials may be easily leached to obtain one or more value metals.

### BACKGROUND

Lithium ion battery materials are complex mixtures of various elements and compounds. For example, many lithium ion battery materials contain valuable metals such as lithium, aluminum, copper, nickel, cobalt, and/or manganese. It may be desirable to recover various elements and compounds from lithium ion battery materials. For example, it may be advantageous to recover lithium, aluminum, copper, nickel, cobalt, and/or manganese. In some battery recycling processes, different process parameters may produce intermediate materials having different compositions and/or properties. Intermediate materials having, for example, a favorable composition, mechanical properties, surface hydrophilicity, and/or porosity may, e.g., result in improved processibility and/or recovery in subsequent downstream processing steps. Such downstream processing steps may, for example, be part of a lithium ion battery recycling process and/or more general metal recycling and/or recovering steps.

Accordingly, there is a need for materials having improved processibility and/or metal recovery in subsequent downstream recycling and/or recovery processes. For example, there is a need for intermediate lithium ion battery recycling materials having, for example, a favorable composition, mechanical properties, surface hydrophilicity, and/or porosity. Further, there is a need for improved battery recycling processes for producing such improved intermediate materials.

LOMBARDO, Gabriele et al.: “Chemical Transformations in Li-Ion Battery Electrode Materials by Carbothermic Reduction”, ACS SUSTAINABLE CHEMISTRY & ENGINEERING, vol. 7, no. 16 (2019) pp. 13668-13679 relates to the effects of pyrolysis om the composition of battery cell materials as a function of treatment time and temperature. Waste of Li-ion batteries was pyrolyzed in a nitrogen atmosphere at 400, 500, 600, and 700° C. for 30, 60, and 90 min. Treatment of a mix of cathodes and anodes of an NMC Li-ion battery at a temperature between 40° and 700° C. triggers a carbothermic reduction of the cathode active material, and Co, Mn, and Ni are obtained in a lower oxidation state.

WO 2021/201055 A1 discloses a heat treatment method for battery-waste containing lithium. The method comprises: causing an atmospheric gas containing oxygen and at least one selected from the group consisting of nitrogen, carbon dioxide, and water vapor to flow in a heat treatment furnace in which battery waste is disposed; and heating the battery waste while adjusting the partial pressure of oxygen in the furnace.

JP 2020/191184 A discloses a method for recovering a foil and an active material from a positive electrode for a non-aqueous electrolyte secondary battery which enables the foil to be prevented from embrittling and thereby enabling the foil and the active material to be easily separated and recovered. The method includes adding an additive to a positive electrode, and heating the positive electrode to which the additive is added. The non-aqueous electrolyte and a binder are thermally decomposed to generate HF and a carbon oxide when the positive electrode is heated, and the HF and the carbon oxide react with the additive added to the positive electrode before the HF and carbon oxide react with Al included in the foil, preventing embrittlement of the foil.

### SUMMARY OF THE INVENTION

Disclosed herein are aluminum composite materials comprising from 1 wt % to 80 wt % aluminum, from 1 wt % to 20 wt % manganese, from 1 wt % to 20 wt % cobalt, and from 2 wt % to 50 wt % nickel; wherein each wt % is by total weight of the aluminum composite material and the wt % aluminum plus the wt % manganese plus the wt % cobalt plus the wt % nickel is less than or equal to 100% The aluminum composite material has a mean force at puncture ranging from 0.1 N to 1.5 N; wherein the mean force at puncture is determined by determination of puncture resistance European Standard EN 14477:2004.

A process for preparing the composite material also is provided. The process comprises providing an intermediate lithium ion battery recycling material comprising an aluminum foil and a cathode active material (CAM) at a first temperature; heating the intermediate lithium ion battery recycling material at a second temperature ranging from 400° C. to 630° C. and contacting the material with a gas comprising less than 1 volume % oxygen and comprising at least one chosen from a combustible gas, a reductive gas, carbon dioxide (CO₂), and an inert gas to obtain the aluminum composite material; optionally cooling the aluminum composite material to a third temperature ranging from 10° C. to 100° C.

Further, the use of the composite material in the recovery of valuable materials from lithium ion batteries is provided.

### BRIEF DESCRIPTION OF THE DRAWINGS

FIG. 1 shows an exemplary process for preparing an exemplary aluminum composite material;

FIG. 2 shows an exemplary downstream process for recovering value metals from an exemplary aluminum composite material;

FIG. 3 depicts an XRD pattern of an exemplary aluminum composite material;

FIG. 4 shows a SEM image of an exemplary intermediate lithium ion battery material comprising an aluminum foil coated with cathode active material on both faces;

FIG. 5 shows a SEM image of an exemplary aluminum composite material;

FIG. 6 shows a SEM image and an EDX image of an exemplary aluminum composite material.

### DEFINITIONS

As used herein, the term “composite material” refers to a material comprising two or more different constituents.

As used herein, the term “intermediate lithium ion battery recycling material” refers to a material obtainable by mechanical processing of lithium ion batteries or battery scrap and comprising aluminum foil and a cathode active material (CAM).

As used herein, a “reductive gas” is a gas capable of reducing a metal oxide and/or a metal hydroxide. For example, some reducing agents are capable of reducing some metal oxides and/or some metal hydroxides but not others.

As used herein, a “combustible gas” is a gas capable of being combusted when exposed to oxygen and a flame.

As used herein, “hydrocarbons” are compounds consisting of carbon and hydrogen. For example, “C₁ to C₁₀ hydrocarbons” refers to one or more hydrocarbons having a total number of carbon atoms ranging from 1 to 10.

As used herein, “oxy-hydrocarbons” are compounds consisting of oxygen, carbon, and, optionally, hydrogen. Exemplary oxy-hydrocarbons include carbon monoxide, carbon dioxide, ethanol, and acetone. Also, “C₁ to C₁₀ oxy-hydrocarbons”refers to one or more oxy-hydrocarbons having a total number of carbon atoms ranging from 1 to 10.

Unless otherwise stated, all temperatures refer to the temperature of the environment in which a material is located and may or may not be different from the temperature of the material itself.

### DETAILED DESCRIPTION OF THE DRAWINGS

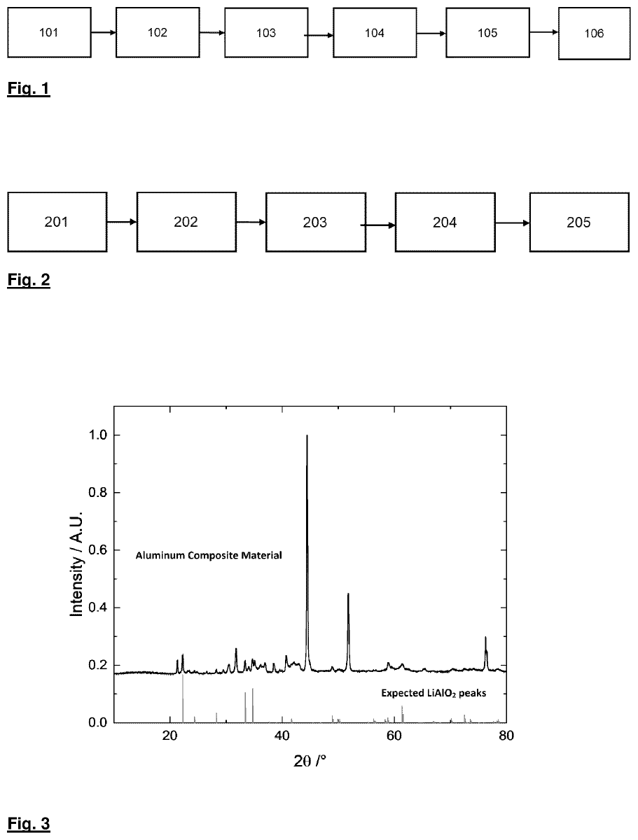

FIG. 1 depicts an exemplary process for preparing an exemplary aluminum composite material from a lithium ion battery material. In Steps 101 and 102, the lithium ion battery is discharged and dismantled to obtain a lithium ion battery material. In Step 103, the lithium ion battery material is shredded. The shredded lithium ion battery material is dried in step 104 to remove solvent and sieved in step 105 before being subjected to a pyrolysis process in step 106.

FIG. 2 depicts an exemplary downstream process for recovering value metals from an exemplary composite material. After pyrolysis in step 201, the aluminum composite material is leached in an acid solution in step 202, various impurities are removed in step 203. Subsequently, nickel and/or cobalt are extracted in step 204 and lithium is recovered in step 205.

FIG. 3 depicts a XRD pattern of an exemplary aluminum composite material (top curve). The lines at the bottom panel indicate expected positions of the diffraction lines for LiAlO₂.

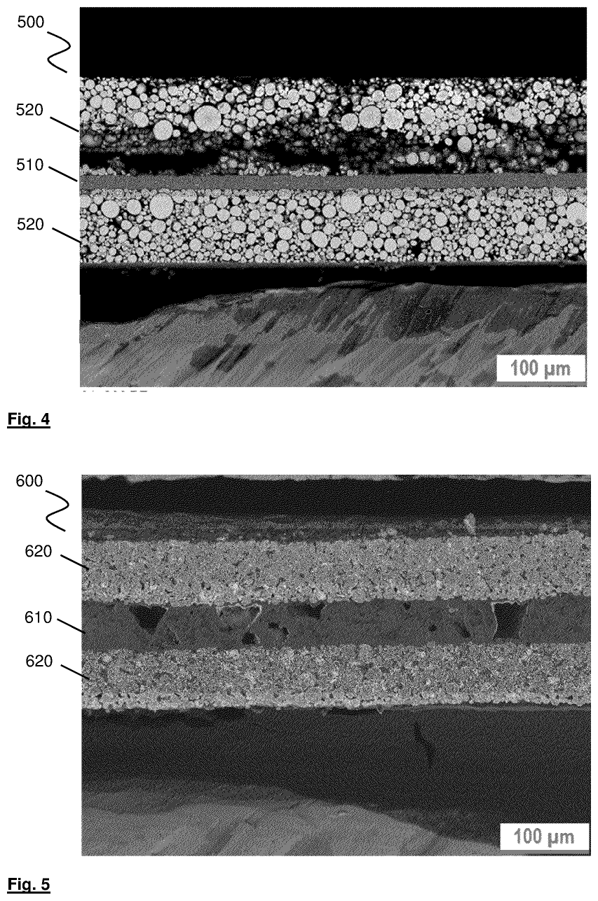

FIG. 4 shows a SEM image of an exemplary intermediate lithium ion battery material 500 comprising an aluminum foil 510 coated with cathode active material 520. The intermediate lithium ion battery material 500 can be used in the process of the present disclosure to produce an aluminum composite material.

FIG. 5 shows a SEM image of an exemplary aluminum composite material 600 of the present disclosure derived from the intermediate lithium ion battery material 500 of FIG. 4. The porous, weathered structure of the central layer 610 derived from the aluminum foil 510 is clearly visible. Adjacent to the central layer 610, layers 620 derived from the cathode active material 520 of FIG. 4 are present.

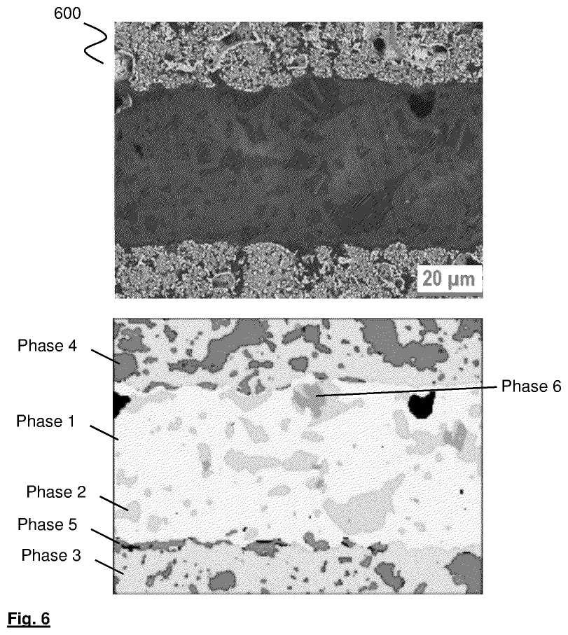

FIG. 6 shows a SEM image (top) of the aluminum composite material 600 of FIG. 5 with higher resolution and the corresponding EDX image (bottom).

### DETAILED DESCRIPTION

### Aluminum Composite Material

The present disclosure provides aluminum composite materials comprising from 1 wt % to 80 wt % aluminum, from 1 wt % to 20 wt % manganese, from 1 wt % to 20 wt % cobalt, and from 0 wt % to 50 wt % nickel; wherein each wt % is by total weight of the aluminum composite material and the wt % aluminum plus the wt % manganese plus the wt % cobalt plus the wt % nickel is less than or equal to 100%.

In some embodiments, the aluminum composite material comprises from 1 wt % to 60 wt % aluminum, based on the total weight of the aluminum composite material.

In some embodiments, the aluminum composite material comprises from 0 to 45 wt %, e.g., 2 to 35 wt %, for instance, from 11 to 26 wt %, of nickel, based on the total weight of the aluminum composite material.

In some embodiments, the aluminum composite material further comprises lithium and oxygen.

The aluminum composite material has a mean force at puncture ranging from 0.1 N to 1.5 N; wherein the mean force at puncture is determined by determination of puncture resistance European Standard EN 14477:2004.

The aluminum composite material has beneficial properties for improving one or more downstream processes such as leaching. For example, at least some of the aluminum in the aluminum composite material is present as an oxide formed which reduces the amount of dihydrogen gas (H₂) evolved during a subsequent leaching step.

Also, the embrittlement of the aluminum composite material may, e.g., result in smaller particles which have a more beneficial surface-to-volume ratio facilitating dissolution during acid leaching. The smaller particle size may additionally facilitate subsequent transport steps, such as conveying.

In some embodiments, the aluminum composite material has a hydrophilic surface; wherein the surface hydrophilicity is determined by sessile drop static water contact angle. In some embodiments, the aluminum composite material has a sessile drop static water contact angle ranging from 1° to 30°.

In some embodiments, the aluminum composite material has an X-ray diffraction pattern, determined by powder X-ray diffraction (P-XRD) using Cu K_{α} radiation, comprising a reflection at a 2 theta diffraction angle ranging from 21.7 to 22.8 having an intensity normalized to 100, a reflection at a 2 theta diffraction angle ranging from 32.8 to 33.9 having an intensity ranging from 55 to 75, a reflection at a 2 theta diffraction angle ranging from 34.2 to 35.2 having an intensity ranging from 65 to 85, a reflection at a 2 theta diffraction angle ranging from 60.8 to 61.9 having an intensity ranging from 34 to 54, and a reflection at a 2 theta diffraction angle ranging from 27.7 to 28.8 having an intensity ranging from 12 to 32.

In some embodiments, the aluminum composite material has a porosity ranging from 5% to 80%; wherein the porosity is determined by scanning electron microscopy as described below. In some embodiments, the aluminum composite material has a porosity ranging from 10% to 60%; in some embodiments, the aluminum composite material has a porosity ranging from 15% to 40%.

In some embodiments, the aluminum composite material is prepared according to a process disclosed herein.

### Process for Preparing the Aluminum Composite Materials

The present disclosure also provides a process for preparing the aluminum composite material. The process comprises
a) providing an intermediate lithium ion battery recycling material comprising an aluminum foil and a cathode active material (CAM) and having an average particle diameter (D₅₀), measured by laser light scattering as described below, in the range of from 1 μm to 500 μm at a first temperature;
b) heating the intermediate lithium ion battery recycling material at a second temperature ranging from 400° C. to 630° C.;
c) contacting the intermediate lithium ion battery recycling material with a gas comprising less than 1 volume % oxygen and comprising at least one chosen from a combustible gas, a reductive gas, carbon dioxide (CO₂), and an inert gas, to obtain the aluminum composite material;
d) optionally, subsequently cooling the aluminum composite material to a third temperature ranging from 10° C. to 100° C.

In some embodiments of the process, at the heating step, the intermediate lithium ion battery recycling material further comprises at least one organic material chosen from polymeric binders, conductive carbon, organic carbonates, and combinations thereof, and the reductive gas is generated in situ by thermal decomposition of the at least one organic material.

In some embodiments of the process, the organic material comprises at least one chosen from polyvinylidene fluoride, polyethylene, polypropylene, ethyl methyl carbonate, ethylene carbonate, dimethyl carbonate, diethyl carbonate, propylene carbonate, and combinations thereof.

In some embodiments of the process, the reductive gas comprises: from 5 volume % to 70 volume % C₁ to C₁₀ hydrocarbons, from 5 volume % to 45 volume % carbon dioxide (CO₂), from 0.1 volume % to 10 volume % carbon monoxide (CO), and from 1 volume % to 15 volume % H₂; wherein each volume % is by total volume of the reductive gas and the volume % of C₁ to C₁₀ hydrocarbons plus the volume % of CO₂ plus the volume % of carbon monoxide (CO) plus the volume % of H₂ is less than or equal to 100%.

In some embodiments, the reductive gas comprises at least one gas chosen from argon (Ar), dinitrogen (N₂), carbon dioxide (CO₂), helium (He), and mixtures thereof, and at least one gas chosen from the group of hydrocarbons, dihydrogen gas (H₂), carbon monoxide (CO), and mixtures thereof.

In some embodiments of the process, the provided intermediate lithium ion battery recycling material comprising an aluminum foil and a cathode active material is obtained by a process comprising: shredding a battery material, and drying the shredded battery material.

In some embodiments of the process, the first temperature ranges from −10° C. to 50° C. In some embodiments of the process, the first temperature ranges from 0° C. to 35° C. In some embodiments, the first temperature is ambient temperature.

In some embodiments of the process, the heating step comprises dwelling at one or more intermediate temperatures ranging from the first temperature to the second temperature. In some embodiments of the process, the heating step comprises dwelling at two or more intermediate temperatures ranging from the first temperature to the second temperature. In some embodiments of the process, the heating step comprises dwelling at one or more intermediate temperatures ranging from the first temperature to the second temperature; wherein each dwelling time ranges from 5 minutes to 3 hours. In some embodiments of the process, the heating step comprises dwelling at one or more intermediate temperatures ranging from the first temperature to the second temperature; wherein each dwelling time ranges from 5 minutes to 2 hours. In some embodiments of the process, the heating step comprises dwelling at one or more intermediate temperatures ranging from the first temperature to the second temperature; wherein each dwelling time ranges from 5 minutes to 1 hour. In some embodiments of the process, the heating step comprises dwelling at one or more intermediate temperatures ranging from the first temperature to the second temperature; wherein each dwelling time ranges from 5 minutes to 30 minutes.

In some embodiments of the process, the heating step comprises a temperature ramp from the first temperature to the second temperature over a period of 10 minutes to 2 hours. In some embodiments of the process, the heating step comprises a temperature ramp from the first temperature to the second temperature over a period of 10 minutes to 1 hour. In some embodiments of the process, the heating step comprises a temperature ramp from the first temperature to the second temperature over a period of 10 minutes to 30 minutes.

In some embodiments, a temperature ramp has an average rate of temperature increase of at least 1K per minute. In some embodiments, a temperature ramp has average rate of temperature increase of at least 5K per minute. In some embodiments, a temperature ramp has average rate of temperature increase of at least 10K per minute. In some embodiments, a temperature ramp has average rate of temperature increase of at least 15K per minute. In some embodiments, a temperature ramp has average rate of temperature increase of at least 20K per minute. In some embodiments, a temperature ramp has average rate of temperature increase of at least 25K per minute. In some embodiments, a temperature ramp has average rate of temperature increase ranging from 1K per minute to 100K per minute. In some embodiments, a temperature ramp has average rate of temperature increase ranging from 10K per minute to 50K per minute.

In some embodiments of the process, the second temperature ranges from 400° C. to 630° C. In some embodiments of the process, the second temperature ranges from 450° C. to 630° C. In some embodiments of the process, the second temperature ranges from 500° C. to 630° C.

In some embodiments, the material does not at least partially transition from a solid state to a liquid state during any of the heating steps. In some embodiments, at least 95 wt % of the material remains a solid during all of the heating steps; by total weight of the material. In some embodiments, at least 90 wt % of the material remains a solid during all of the heating steps; by total weight of the material. In some embodiments, at least 80 wt % of the material remains a solid during all of the heating steps; by total weight of the material. In some embodiments, at least 50 wt % of the material remains a solid during all of the heating steps; by total weight of the material. In some embodiments, the material does not completely transition from a solid state to a liquid state during any of the heating steps.

In some embodiments, the process further comprises dwelling at the second temperature for a period of time ranging from 0 minutes to 2 hours. In some embodiments, the process further comprises dwelling at the second temperature for a period of time ranging from 1 minute to 2 hours. In some embodiments, the process further comprises dwelling at the second temperature for a period of time ranging from 10 minutes to 2 hours. In some embodiments, the process further comprises dwelling at the second temperature for a period of time ranging from 10 minutes to 1 hour.

In some embodiments, a process for preparing an aluminum composite material comprises: providing an intermediate lithium ion battery recycling material comprising an aluminum foil and a cathode active material at a first temperature ranging from −10° C. to 50° C.; heating the intermediate lithium ion battery recycling material at a second temperature ranging from 480° C. to 630° C.; wherein the heating step comprises a temperature ramp from the ambient first temperature to the second temperature over a period of time ranging from 10 minutes to 1 hour; dwelling at the second temperature for a time ranging from 0 minutes to 1 hour; contacting the intermediate lithium ion battery recycling material with a gas comprising less than 1 volume % oxygen and comprising at least one chosen from a combustible gas, a reductive gas, CO₂, an inert gas, and combinations thereof to obtain the aluminum composite material; and, optionally, cooling the aluminum composite material to a third temperature ranging from 50° C. to 70° C.

In some embodiments, a process for preparing an aluminum composite material comprises: providing an intermediate lithium ion battery recycling material comprising an aluminum foil and a cathode active material at a first ambient temperature; heating the intermediate lithium ion battery recycling material at a second temperature ranging from 480° C. to 580° C.; wherein the heating step comprises a temperature ramp from the ambient first temperature to the second temperature over a period of time ranging from 10 minutes to 1 hour; dwelling at the second temperature for a time ranging from 0 minutes to 1 hour, contacting the intermediate lithium ion battery recycling material with a gas comprising less than 1 vol.-% oxygen and comprising at least one chosen from a combustible gas, a reductive gas, CO₂, an inert gas, and combinations thereof to obtain the aluminum composite material; and, optionally, cooling the aluminum composite material to a third temperature ranging from 50° C. to 70° C.

In some embodiments, the aluminum composite material is characterized by an x-ray diffraction pattern substantially as shown in FIG. 3.

### Intermediate Lithium Ion Battery Recycling Material

The intermediate lithium ion battery recycling material of the present disclosure comprises an aluminum foil and a cathode active material (CAM) adhering to at least one of the surfaces of the aluminum foil. In some embodiment, the CAM adheres to both faces of the aluminum foil.

Lithium ion batteries may be disassembled, punched, milled, for example in a hammer mill, rotor mill, and/or shredded, for example in an industrial shredder.

From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D50), measured by sieve analysis according to DIN 66165, ranging from 1 μm to 1 cm, such as from 1 μm to 500 μm, and further, for example, from 3 μm to 250 μm. The material may have an average particle diameter (D50), measured by laser light scattering as described below, ranging from 1 μm to 1 cm, such as from 1 μm to 500 μm, and further, for example, from 3 μm to 250 μm.

Larger parts of the battery scrap like the housings, the wiring and the electrode carrier films may be separated mechanically such that the corresponding materials may be excluded from the battery material that is employed in the disclosed process. In some embodiments, the separation is done by manual or automated sorting. For example, magnetic parts can be separated by magnetic separation non-magnetic metals by eddy-current separators. Other techniques may comprise jigs and air tables.

Mechanically treated battery scrap may be subjected to a solvent treatment in order to dissolve and separate polymeric binders used to bind the transition metal oxides to current collector films, or, e.g., to bind graphite to current collector films. Examples of suitable solvents include, but are not limited to, N-methylpyrrolidone, N,N-dimethylformamide, N,N-dimethylacetamide, N-ethyl-pyrrolidone, and dimethylsulfoxide, in pure form, as mixtures of at least two of the foregoing, or as a mixture with 1% to 99% by weight of water; by total weight of the mixture.

In some embodiments, the intermediate lithium ion battery recycling material comprises nickel, cobalt, manganese, copper, aluminum, iron, phosphorus, or combinations thereof.

In some embodiments, the intermediate lithium ion battery recycling material has a weight ratio ranging from 0.01 to 10 of lithium to a total weight of nickel, cobalt, manganese, copper, aluminum, iron, and phosphorus. In some embodiments, intermediate lithium ion battery recycling material has a weight ratio ranging from 0.01 to 5 of lithium to a total weight of nickel, cobalt, manganese, copper, aluminum, iron, and phosphorus. In some embodiments, intermediate lithium ion battery recycling material has a weight ratio ranging from 0.01 to 2 of lithium to a total weight of nickel, cobalt, manganese, copper, aluminum, iron, and phosphorus. In some embodiments, intermediate lithium ion battery recycling material has a weight ratio ranging from 0.01 to 1 of lithium to a total weight of nickel, cobalt, manganese, copper, aluminum, iron, and phosphorus.

In some embodiments, the intermediate lithium ion battery recycling material shows a particle size distribution, determined by laser light scattering as described below, having a D(10) value in the range of from 2 to 6 μm, e.g., from 4 to 5 μm, a D(50) value in the range of from 10 to 30 μm, and a D(90) value in the range of from 150 to 250 μm. In some embodiments, the intermediate lithium ion battery recycling material has a D(10) value in the range of from 4 to 4.5 μm, a D(50) value in the range of from 20 to 25 μm, and a D(90) value in the range of from 200 to 210 μm. In particular embodiments, the intermediate lithium ion battery recycling material has a D(10) value of 4.2 μm, a D(50) value of 22.4 μm, and a D(90) value of 203 μm. In other embodiments, the intermediate lithium ion battery recycling material has a D(10) value in the range of from 4 to 4.5 μm, a D(50) value in the range of from 12 to 16 μm, and a D(90) value in the range of from 140 to 170 μm. In particular embodiments, the intermediate lithium ion battery recycling material has a D(10) value of 4.2 μm, a D(50) value of 14.1 μm, and a D(90) value of 158 μm.

For example, the particle size distribution can be measured by dispersing a sample of the intermediate lithium ion battery recycling material in water comprising a non-ionic surfactant and measuring the dispersion in a laser diffraction particle size analyzer, e.g., a Mastersizer® 3000, Malvern Panalytical GmbH, 34123 Kassel, Germany) coupled to an automated dispersion unit (Hydro MV, Malvern Panalytical GmbH, 34123 Kassel, Germany). In a specific example, the sample is dispersed in 120 ml water comprising 1-2 ml of a polyethylene glycol ether (0.5 wt % solution of Lutensol® XL 80, BASF SE), stirring at 3500 rpm and using 2 min of ultrasound sonification.

In some embodiments of the process, the provided intermediate lithium ion battery recycling material comprises an aluminum foil and a cathode active material and is obtained by a process comprising: shredding a battery material, and drying the shredded battery material.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof.

In some embodiments, the intermediate lithium ion battery recycling material comprises from 1 weight % to 90 weight % aluminum in a zero oxidation state as aluminum foil and from 1 weight % to 90 weight % cathode active material; wherein each weight % is by total weight of the intermediate lithium ion battery recycling material. In some embodiments, the intermediate lithium ion battery recycling material comprises from 1 weight % to 75 weight % aluminum in a zero oxidation state as aluminum foil and from 1 weight % to 75 weight % cathode active material; wherein each weight % is by total weight of the intermediate lithium ion battery recycling material. In some embodiments, the intermediate lithium ion battery recycling material comprises from 10 weight % to 75 weight % aluminum in a zero oxidation state as aluminum foil and from 10 weight % to 75 weight % cathode active material; wherein each weight % is by total weight of the intermediate lithium ion battery recycling material. In some embodiments, the intermediate lithium ion battery recycling material comprises from 1 weight % to 5 weight % aluminum in a zero oxidation state as aluminum foil and from 50 weight % to 95 weight % cathode active material; wherein each weight % is by total weight of the intermediate lithium ion battery recycling material.

### Cathode Active Material

The intermediate lithium ion battery recycling material used in the process of the present disclosure comprises a cathode active material (CAM). In some embodiments of the process, the cathode active material corresponds to formula LiₚM_{q}M′ᵣOₛ. In some embodiments, M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4.

In some embodiments, the cathode active material comprises lithiated nickel cobalt manganese oxide of formula Li₍₁₊ₓ₎(NiₐCO_{b}Mn_{c}M_{d})₍₁₋ₓ₎O₂, wherein: M′ is chosen from Mg, Ca, Ba, Al, Ti, Zr, Zn, Mo, V and Fe; zero≤x≤0.2; 0.1≤a≤0.95, zero≤b≤0.9, or 0.05<b≤0.5; zero≤c≤0.6; zero≤d≤0.1; and a+b+c+d=1.

In some embodiments, the cathode active material comprises lithiated nickel-cobalt aluminum oxides of formula Li[NiₕCoᵢAlⱼ]O₂₊ₜ, wherein: h ranges from 0.8 to 0.95; i ranges from 0.1 to 0.3; j ranges from 0.01 to 0.10; and t ranges from zero to 0.4.

In some embodiments, the cathode active material comprises lithiated manganese oxides of formula Li₍₁₊ₓ₎Mn_{2-x-y-z}M_{y}M′_{z}O₄, wherein: x ranges from zero to 0.2; y+z ranges from zero to 0.1; and M is chosen from Al, Mg, Fe, Ti, V, Zr and Zn.

In some embodiments, the cathode active material comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal and 0<x<1, 0<y<1, 0<z<1 and x+y+z=1.

In some embodiments, the cathode active material comprises at least one cathode active material chosen from lithiated nickel cobalt manganese oxide, lithiated nickel cobalt aluminum oxide, lithiated manganese oxide, lithium ion battery scrap comprising cathode active materials such as production waste from the production of cathode active materials, and combinations thereof.

In some embodiments the cathode active material comprises lithiated nickel cobalt manganese oxide of formula Li₁₊ₓ(NiₐCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include Li₍₁₊ₓ₎[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3}]₍₁₋ₓ₎O₂, Li₍₁₊ₓ₎[Ni_{0.8}Co_{0.1}Mn_{0.1}]₍₁₋ₓ₎O₂ each with x as defined above, and Li[Ni_{0.85}Co_{0.13}Al_{0.02}]O₂.

In some embodiments, the cathode active material comprises lithiated nickel-cobalt aluminum oxides of formula Li[NiₕCoᵢAlⱼ]O₂₊ₜ, wherein h ranges from 0.8 to 0.95, i ranges from 0.1 to 0.3, j ranges from 0.01 to 0.10, and t ranges from zero to 0.4.

In some embodiments, the cathode active material comprises LiₓMO₂; wherein x is an integer greater than or equal to one, and M is chosen from metals, transition metals, rare earth metals, and combinations thereof.

In some embodiments, the cathode active material comprises lithiated manganese oxides of formula Li₍₁₊ₓ₎Mn_{2-x-y-z}M_{y}M′_{z}O₄, wherein: x ranges from zero to 0.2; y+z ranges from zero to 0.1; and M′ is chosen from Al, Mg, Fe, Ti, V, Zr and Zn.

In some embodiments, the cathode active material comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal and 0<x<1, 0<y<1, 0<z<1 and x+y+z=1.

In some embodiments, the cathode active material comprises LiCoO₂. In some embodiments, the cathode active material comprises LiFePO₄.

In some embodiments, the cathode active material is prepared according to a process disclosed in WO 2019/011 786 A1.

In some embodiments, the cathode active material is prepared by a process for making an electrode active material according to general formula Li₁₊ₓTM₁₋ₓO₂, wherein TM is a combination of metals comprising Mn, Co, and Ni and at least one metal M chosen from Al, Ti, and W, wherein at least 60 mole-% of TM is Ni, the percentage referring to the sum of Ni, Co, and Mn, and x ranges from zero to 0.2, wherein the process comprises: (a) mixing (A) a mixed oxide or mixed oxyhydroxide of Mn, Co, and Ni, and (B) at least one lithium compound chosen from lithium hydroxide, lithium oxide and lithium carbonate, and (C) an oxide, hydroxide or oxyhydroxide of Al, Ti, or W, (b) subjecting the mixture to heat treatment at a temperature in the range of from 700° C. to 1000° C.

In some embodiments, the cathode active material is prepared by a process wherein TM in the electrode active material is a combination of metals according to general formula (I) (NiₐCo_{b}Mn_{c})_{1-d}M_{d} (I) with a ranging from 0.6 to 0.85, b ranging from 0.05 to 0.2, c ranging from 0.05 to 0.2, and d ranging from 0.005 to 0.1, and M is Al, and a+b+c=1.

In some embodiments, the cathode active material is prepared by a process wherein the mixing in step (a) is performed in the dry state.

In some embodiments, the cathode active material is prepared by a process wherein step (b) is performed in a rotary kiln or roller hearth kiln.

In some embodiments, the cathode active material is prepared by a process wherein (C) is Al₂O₃.

In some embodiments, the cathode active material is prepared by a process wherein (A) is an oxide of Mn, Co, and Ni.

In some embodiments, the cathode active material is prepared by a process wherein precursor (A) is obtained by co-precipitation of a mixed hydroxide of nickel, cobalt and manganese, followed by drying under air and dehydration.

In some embodiments, the cathode active material has a surface (BET) ranging from 0.1 m²/g to 0.8 m²/g, determined according to DIN-ISO 9277:2003-05.

The process of the present disclosure comprises contacting the intermediate lithium ion battery recycling material with an inert gas and with a reductive gas generated in situ by thermal decomposition of the intermediate lithium ion battery recycling material to obtain the composite material.

In some embodiments, the flow rate of the inert gas is in the range of from 100 to 300 Sm³/h, e.g. 150 to 250 Sm³/h, for instance, 200 Sm³/h (standard cubic meter per hour).

In some embodiments, the inert gas comprises at least one gas chosen from argon (Ar), dinitrogen (N₂), helium (He), and mixtures thereof.

In some embodiments, the reductive gas comprises at least one gas chosen from the group of hydrocarbons, dihydrogen gas (H₂), carbon monoxide (CO), and mixtures thereof.

In some embodiments of the process, the reductive gas comprises: from 5 volume % to 70 volume % C₁ to C₁₀ hydrocarbons, from 5 volume % to 95 volume % carbon dioxide (CO₂), from 0.1 volume % to 10 volume % carbon monoxide (CO), and from 0.1 volume % to 15 volume % H₂; wherein each volume % is by total volume of the reductive gas and the volume % of C₁ to C₁₀ hydrocarbons plus the volume % of CO₂ plus the volume % of H₂ is less than or equal to 100%.

In some embodiments of the process, the reductive gas comprises: from 5 volume % to 70 volume % C₁ to C₁₀ hydrocarbons, from 5 volume % to 45 volume % C₁ to C₁₀ oxy-hydrocarbons, and from 0.1 volume % to 15 volume % H₂; wherein each volume % is by total volume of the reductive gas and the volume % of C₁ to C₁₀ hydrocarbons plus the volume % C₁ to C₁₀ oxy-hydrocarbons plus the volume % of H₂ is less than or equal to 100%.

In some embodiments of the process, the heating step is performed in a rotary kiln. The rotary kiln is a cylindrical vessel, inclined slightly from the horizontal, which is rotated slowly about its longitudinal axis. The process feedstock is fed into the upper end of the cylinder. As the kiln rotates, material gradually moves down toward the lower end, and may undergo a certain amount of stirring and mixing.

In some embodiments of the process, the kiln has a length in the range of from 12 to 18 m. In some embodiments of the process, the kiln has a length in the range of from 15 to 17 m. Kiln length refers to the length of the heated zone of the kiln. Additional elements will make the overall kiln a little bit longer. In some embodiments of the process, the inner diameter of the cylindrical tube is in the range of from 1.5 m to 2.2 m, e.g., from 1.7 m to 1.9 m.

In some embodiments of the process, the kiln is filled with a volume of intermediate lithium ion battery recycling material equal to 5 to 20%, e.g., from 7% to 16%, for instance, from 9% to 12%, of the total volume of the kiln.

In some embodiments of the process, the intermediate lithium ion battery recycling material is fed to the kiln using at least one screw conveyor.

In some embodiments of the process, the kiln rotates at 0.5 to 3 rpm. In some embodiments of the process, the kiln rotates at 1.4 to 2.6 rpm. In some embodiments of the process, the kiln rotates at 1.8 to 2.2 rpm.

In some embodiments of the process, overpressure is maintained in the kiln during operation to prevent air from entering the kiln.

In some embodiments of the process, hot gases pass along the kiln in the same direction as the process material (concurrent). In some embodiments of the process, the intermediate lithium ion battery recycling material and an inert gas are fed to the rotary kiln in concurrent flow. The concurrent flow makes sure that no dust emerges from the upper end of the kiln. The concurrent flow also makes sure that gas generated during pyrolysis does not get to the inlet section of the rotary kiln and form a condensate on the walls of the kiln.

In some embodiments of the process, the rotary kiln is heated by external heating elements using electric power. In some embodiments of the process, the kiln comprises several heating zones. In some embodiments of the process, each an every heating zone is operated at a temperature in the range of from 520 to 630° C. In some embodiments, thermoelements are provided in each of the heating zones for measuring the temperature in the respective zone. In one embodiment, each heating zone has a length of from 0.5 m to 6 m, e.g., from 1 m to 4 m, for instance, from 1.5 m to 3 m.

In some embodiments of the process, the kiln connects with a material exit hood at the lower end and ducts for waste gases. This requires gas-tight seals at either end of the kiln. The exhaust gas contains hydrocarbons. Equipment is installed to eliminate these from the gas stream before passing to the atmosphere.

In some embodiments, the process of the present disclosure involves cooling the composite material obtained to a third temperature ranging from 10° C. to 100° C., e.g., from 20° C. to 50° C. In some embodiments, cooling is performed in a rotary cooler positioned at the lower end of the rotary kiln. In some embodiments, the rotary cooler has the same diameter as the rotary kiln and is cooled by a water jacket. In some embodiments of the process the inside of the rotary cooler is flushed with an inert gas, e.g., nitrogen gas.

In some embodiments of the process, the composite material exiting the rotary kiln falls into the rotary cooler, while exhaust gas leaving the rotary kiln is drawn off without being cooled. This prevents condensation of hydrocarbons present in the exhaust gas onto the composite material.

As provided herein, different process parameters may produce intermediate materials having different compositions and/or properties. Intermediate materials having, for example, a favorable composition, mechanical properties, surface hydrophilicity, and/or porosity may, e.g., result in improved processibility and/or recovery in subsequent downstream processing steps.

The present disclosure also provides a use of the aluminum composite material of the present disclosure in the recovery of valuable materials from lithium ion batteries, e.g., from an intermediate lithium ion battery recycling material. In some embodiments, the composite materials are used as intermediates for a downstream leaching process.

For example, a black mass fraction comprising the composite material can be leached with an acidic aqueous solution comprising, e.g., sulfuric acid (H₂SO₄) to obtain a solution comprising one or more value metal ions. The solution comprising one or more value metal ions may be further purified via, e.g., solvent exchange, ion-exchange, precipitation, extraction, and/or electrolysis.

Without wishing to be bound by theory, it is believed that the composite material has beneficial properties for improving one or more downstream processes such as leaching. For example, it is believed that at least some of the aluminum in the aluminum composite material is present as an oxide formed and reduces the amount of dihydrogen gas (H₂) evolved during a subsequent leaching step. This would, e.g., improve the safety of a subsequent leaching step.

Also, it is believed that the embrittlement of the aluminum composite material may, e.g., result in smaller particles that have a more beneficial surface-to-volume ratio facilitating dissolution during acid leaching. The smaller particle size may additionally facilitate subsequent transport steps, such as conveying.

In some embodiments, the leaching process involves leaching the composite material to obtain at least one value metal chosen from nickel, cobalt, manganese, and combinations thereof; wherein the obtained at least one value metal has a purity of at least 80% by weight.

In some embodiments, the leaching process comprises contacting the composite material with an acidic aqueous solution having a pH less than 6. In an embodiment of the leaching process, the acidic aqueous solution comprises at least one acid chosen from hydrochloric acid (HCl), sulfuric acid (H₂SO₄), methane sulfonic acid, and nitric acid.

### Examples 1-37

The following examples are intended to be illustrative and are not meant in any way to limit the scope of the disclosure.

Samples were prepared as follows. First, an intermediate lithium ion battery recycling material comprising an aluminum foil and a cathode active material was provided at a first temperature. The intermediate lithium ion battery recycling material had a D(10) of 4.2 μm, a D(50) of 14.1 μm, and a D(90) of 158 μm, and contained 23.7 wt % carbon, 5.9 wt % aluminum, 13.1 wt % copper, 5.9 wt % cobalt, 5.1 wt % manganese, 15.5 wt % nickel, and 3.2 wt % lithium. Second, the intermediate lithium ion battery recycling material was heated in a rotary kiln from the first temperature T_{Start} to the second temperature T_{Target} by ramping up the temperature during a time interval t_{Ramp} while an argon gas stream was conducted through the rotary kiln. Third, the intermediate lithium ion battery recycling material dwelled at the second temperature for a time t_{Dwell} while an argon gas stream was conducted through the rotary kiln. Details for each example are provided in Table 1.

TABLE 1

| | T_{Start} | T_{Target} | t_{Ramp} | t_{Dwell} | Mean force at |
|---|---|---|---|---|---|
| Example No. | [° C.] | [° C.] | [min] | [min] | puncture [N] |
| 1 | 20 | 350 | 50 | 10 | 2.2 |
| 2 | 20 | 400 | 50 | 10 | 2.1 |
| 3 | 20 | 450 | 50 | 10 | 1.9 |
| 4 | 20 | 500 | 40 | 10 | 1.2 |
| 5 | 20 | 500 | 60 | 10 | 1.2 |
| 6 | 20 | 500 | 40 | 30 | 1.1 |
| 7 | 20 | 500 | 60 | 30 | 0.8 |
| 8 | 10 | 550 | 40 | 0 | 0.8 |
| 9 | 10 | 550 | 40 | 10 | 0.7 |
| 10 | 10 | 550 | 40 | 30 | 0.8 |
| 11 | 10 | 550 | 50 | 0 | 0.7 |
| 12 | 10 | 550 | 50 | 10 | 0.8 |
| 13 | 10 | 550 | 50 | 30 | 0.7 |
| 14 | 10 | 550 | 60 | 0 | 0.6 |
| 15 | 10 | 550 | 60 | 10 | 0.6 |
| 16 | 10 | 550 | 60 | 30 | 0.6 |
| 17 | 30 | 550 | 40 | 0 | 0.6 |
| 18 | 30 | 550 | 40 | 10 | 0.7 |
| 19 | 30 | 550 | 40 | 30 | 0.8 |
| 20 | 30 | 550 | 50 | 0 | 0.7 |
| 21 | 30 | 550 | 50 | 10 | 0.8 |
| 22 | 30 | 550 | 50 | 30 | 0.7 |
| 23 | 30 | 550 | 60 | 0 | 0.6 |
| 24 | 30 | 550 | 60 | 10 | 0.6 |
| 25 | 30 | 550 | 60 | 30 | 0.6 |
| 26 | 30 | 600 | 40 | 0 | 0.8 |
| 27 | 30 | 600 | 40 | 10 | 0.7 |
| 28 | 30 | 600 | 40 | 30 | 0.7 |
| 29 | 30 | 600 | 50 | 0 | 0.6 |
| 30 | 30 | 600 | 50 | 10 | 0.6 |
| 31 | 30 | 600 | 50 | 30 | 0.7 |
| 32 | 30 | 600 | 60 | 0 | 0.6 |
| 33 | 30 | 600 | 60 | 10 | 0.7 |
| 34 | 30 | 600 | 60 | 30 | 0.6 |
| 35 | 20 | 625 | 50 | 10 | 0.6 |
| 36 | 20 | 650 | 50 | 10 | 0.5 |
| 37 | 20 | 700 | 50 | 10 | molten |

### Elemental Analysis

This section describes the analytical methods used for the quantitative determination of the constituents of the composite material of the present disclosure.

### Metal Content

Elemental analysis was performed using a combination of acid dissolution and alkaline-borate fusion digestion with analysis by inductively coupled plasma optical emission spectrometry (ICP-OES) on an inductively coupled plasma optical emission spectrometer (e.g., Agilent 5110 ICP-OES, Agilent Technologies Germany Gmbh & Co. KG, 76337 Waldbronn, Germany).

An aliquot (e.g., about 0.2 g) of the sample material was weighed into a volumetric flask and dissolved under slight heating with 30 ml HCl. After cooling down, the insoluble residue was filtered out and incinerated together with the filter paper in a Pt crucible above an open flame. Subsequently, the residue was calcinated at about 600° C. in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in deionized (DI) water under slight heating and 12 ml of HCl were added. Finally, the solution was joined to the initial filtered solution in the volumetric flask and topped up to its final volume with DI water. Each sample was prepared in triplicate. A blank sample was prepared in an analogous manner.

The digestion solution was analyzed by inductively coupled plasma-optical emission spectrometry (ICP-OES), using external calibration. For some samples, the digestion solution may be diluted before analysis, e.g., adapted to the concentration and calibration range of the respective analyte.

Table 2 shows the results of the elemental analysis of the aluminum composite material obtained in Example 7.

TABLE 2

| Element | Weight Percent |
|---|---|
| Al | 6.0 |
| Co | 11.6 |
| Mn | 10.7 |
| Ni | 34 |

### Powder X-Ray Diffraction

Samples were ground to a fine powder in a mortar. Powder X-ray diffraction was performed at room temperature using a D8 Series 2 Diffractometer with multi sample holder from Bruker. K_{α} line of Cu was used as the X-ray source. The detector was Lynx-Eye from Bruker. Samples were measured in a 20 range between 10°-80° in reflection mode.

FIG. 3 depicts a XRD pattern of the aluminum composite material obtained in Example 7 (Top) with the Bottom panel indicating expected peak positions for LiAlO₂.

### General Procedure for Manufacturing a Cathode Sheet

PVDF binder (Solef® 5130) was dissolved in NMP (Merck) to produce a 10 wt % solution. For cathode preparation, binder solution (3.5 wt %), carbon black (Super C65, 4 wt %) were slurried in NMP. After mixing using a planetary centrifugal mixer (ARE-250, Thinky Corp.; Japan), LiNi_{0.6}Co_{0.2}Mn_{0.2}O₂ (92.5 wt %) was added as CAM and the suspension was mixed again to obtain a lump-free slurry. The slurry was coated onto both faces of an aluminum foil having a thickness of 15 μm using a Erichsen auto coater, followed by drying at 120° C. for 15 minutes at ambient pressure and then at 120° C. for 4 hours in vacuo to obtain coating layers having a thickness in the range of from 60 μm to 90 μm. The loading was 8 to 10 mg/cm². All cathodes were dried at 120° C. for 12 hours. Prior to further use, all electrodes were calendared.

### Scanning Electron Microscopy

To clarify the layered structure, cross-sections of a sample of the intermediate lithium ion battery material used as starting material and of the material obtained in Example 7 were created using an ion beam cutter (ArBlade 5000, Hitachi) and imaged (15 kV) using backscattered electrons (BSE) in a Zeiss Gemini 500 Scanning Electron Microscope. In the BSE images, areas of higher density appear brighter (higher concentration/higher atomic number of elements/lower porosity).

FIG. 4 depicts an SEM image of the intermediate lithium ion battery material 500 used in the examples. The intermediate lithium ion battery material 500 comprises an aluminum foil 510 coated on both faces with cathode active material 520.

FIG. 5 depicts an SEM image of the aluminum composite material 600 obtained in Example 7. The porous, weathered structure of the central layer 610 derived from the aluminum foil 510 is clearly visible. Adjacent to the central layer 610, layers 620 derived from the cathode active material 520 of the intermediate lithium ion battery material 500 are present.

Porosity of the aluminum composite material was estimated from the SEM images as follows. Assuming the initial Al foil to have a porosity of 0%, neglecting any lateral volume expansion, assuming a complete retention of Al within the layer during heat treatment, and assuming a quantitative transformation of the bulk Al to LiAlO₂, the porosity of the specimen after heat treatment can be calculated by subtracting the thickness ratio of the layer before and after heat treatment corrected by the different densities of Al and Al within LiAlO₂ from:

$$Porosity = 1 - \frac{{d}_{Al} \cdot {ϱ}_{Al}}{{d}_{{LiAlO}_{2}} \cdot {ϱ}_{Al in {LiAlO}_{2}}} = \frac{{d}_{Al} \cdot {ϱ}_{Al}}{{d}_{{LiAlO}_{2}} \cdot {ϱ}_{{LiAlO}_{2}} \cdot \frac{{M}_{Al}}{{M}_{{LiAlO}_{2}}}} = \frac{{d}_{Al} \cdot {ϱ}_{Al} \cdot {M}_{{LiAlO}_{2}}}{{d}_{{LiAlO}_{2}} \cdot {ϱ}_{{LiAlO}_{2}} \cdot {M}_{Al}}$$

$$Porosity = 1 - \frac{2.7 \frac{g}{c {m}^{3}} \cdot 65.92 \frac{g}{mol} \cdot {d}_{Al}}{2.63 \frac{g}{c {m}^{3}} \cdot 26.98 \frac{g}{mol} \cdot {d}_{{LiAlO}_{2}}} .$$

By this calculation, the porosity of the aluminum composite material obtained in Example 7 was estimated to be 19.7%.

### Sessile Drop Static Water Contact Angle

Sessile drop static water contact angle measurements were performed using an OCA 50/DataPhysics Instruments device with an optical contact angle measuring and contour analysis system. The aluminum composite material obtained in Example 7 was observed to have a hydrophilic surface with a sessile drop static water contact angle of 14°. By contrast, a thermally untreated Al current collector foil that coated on both sides with a cathode coating was observed to have a hydrophobic surface with a Sessile drop static water contact angle of 110°.

### Determination of Puncture Resistance

Puncture test resistance was determined using European Standard EN 14477:2004. Data reported here is an average of 5 measurements. The puncture test resistance of the aluminum composite material obtained in Example 7 was observed to be 0.8 N. By contrast, the puncture test resistance of a thermally untreated Al current collector foil coated on both sides with a cathode coating was 2.27 N.

### EDXS Analysis

Distribution of C, O, F. P, Al, Ni, Co, and Mn in the cross-sectional samples was analyzed using Energy Dispersive X-Ray Spectroscopy (EDXS) at 15 kV. Based on the element distribution, different phases present in the sample were identified.

FIG. 6 shows an SEM image of the aluminum composite material 600 obtained in Example 7 (top) and the corresponding EDX image (bottom). The cross-sections show that the heat treatment has caused considerable structural changes both in the aluminum foil 510 and the cathode material 520. The central layer 610 derived from the aluminum foil 510 has a thickness of approximately 50 μm and shows high porosity. Phase analysis yielded six different phases in the sample. The composition of the individual phases is shown in Table 3.

TABLE 3

| | C | O | F | Al | P | Mn | Co | Ni |
|---|---|---|---|---|---|---|---|---|
| | [wt | [wt | [wt | [wt | [wt | [wt | [wt | [wt |
| | %] | %] | %] | %] | %] | %] | %] | %] |
| Phase 1 | 10.6 | 54.3 | 13.4 | 18.2 | 1.6 | 0.5 | 0.5 | 1.0 |
| Phase 2 | 18.1 | 76.1 | — | 4.4 | 0.2 | 0.3 | 0.3 | 0.7 |
| Phase 3 | 13.1 | 30.4 | — | 0.3 | 0.3 | 14.4 | 11.1 | 30.4 |
| Phase 4 | 8.1 | 6.4 | — | — | — | 3.3 | 19.6 | 62.6 |
| Phase 5 | 5.0 | 10.2 | 38.2 | 2.0 | 0.1 | 12.4 | 8.4 | 23.2 |
| Phase 6 | 17.7 | 70.7 | — | 0.4 | 10.2 | 0.3 | 0.2 | 0.5 |

Results are given in weight percent, normalized to 100 weight percent total weight. For elements having Z>5, information depth is approximately 2 μm. The detection limit for elements having Z >10 is approximately 0.1 weight percent, für elements having Z≤10 in the range of some percent. Where no value is listed in the table, concentration was below the detection limit.

1. An aluminum composite material comprising from 1 wt.-% to 80 wt.-% aluminum, from 1 wt.-% to 20 wt.-% manganese, from 1 wt.-% to 20 wt.-% cobalt, and from 0 wt.-% to 50 wt.-% nickel; wherein each wt.-% is by total weight of the aluminum composite material and the wt.-% aluminum plus the wt.-% manganese plus the wt.-% cobalt plus the wt.-% nickel is less than or equal to 100%, and the aluminum composite material having a mean force at puncture, determined according to European Standard EN 14477:2004, in the range of from 0.1 N to 1.5 N.

2. The aluminum composite material of claim 1, comprising from 11 to 26 wt.-%, of nickel, based on the total weight of the aluminum composite material.

3. The aluminum composite material of claim 1, further comprising lithium and oxygen.

4. The aluminum composite material of claim 1, having an X-ray diffraction pattern, measured by powder X-ray diffraction (P-XRD) using Cu Kα radiation, comprising a reflection at a 2 theta diffraction angle ranging from 21.7 to 22.8 having an intensity normalized to 100, a reflection at a 2 theta diffraction angle ranging from 32.8 to 33.9 having an intensity ranging from 55 to 75, a reflection at a 2 theta diffraction angle ranging from 34.2 to 35.2 having an intensity ranging from 65 to 85, a reflection at a 2 theta diffraction angle ranging from 60.8 to 61.9 having an intensity ranging from 34 to 54, and a reflection at a 2 theta diffraction angle ranging from 27.7 to 28.8 having an intensity ranging from 12 to 32.

5. The aluminum composite material of claim 1, having a porosity, determined by scanning electron microscopy, ranging from 15 to 80%.

6. A process for preparing an aluminum composite material comprising
a) providing an intermediate lithium ion battery recycling material comprising an aluminum foil and a cathode active material (CAM) and having an average particle diameter (D50), determined by laser light scattering, in the range of from 1 μm to 500 μm at a first temperature ranging from −10° C. to 50° C.;
b) heating the intermediate lithium ion battery recycling material at a second temperature ranging from 400° C. to 630° C.;
c) contacting the intermediate lithium ion battery recycling material with a gas comprising less than 1 volume % oxygen and comprising at least one selected from the group consisting of a combustible gas, a reductive gas, carbon dioxide (CO₂), and an inert gas to obtain the aluminum composite material; and
d) optionally, subsequently cooling the aluminum composite material to a third temperature ranging from 10° C. to 100° C.

7. The process of claim 6, wherein the heating step b) comprises ramping up the temperature from the first temperature to the second temperature over a period of from 10 minutes to 2 hours.

8. The process of claim 7, wherein the temperature ramp has an average rate of temperature increase of at least 1K per minute.

9. The process of claim 6, further comprising dwelling at the second temperature for a period of time ranging from 0 minutes to 2 hours.

10. The process of claim 6, wherein the intermediate lithium ion battery recycling material is selected from the group consisting of nickel, cobalt, manganese, copper, aluminum, iron, phosphorus, and combinations thereof.

11. The process of claim 6, wherein the intermediate lithium ion battery recycling material further comprises at least one organic material selected from the group consisting of polymeric binders, conductive carbon, organic carbonates, and combinations thereof, and the reductive gas is generated in situ by thermal decomposition of the at least one organic material.

12. The process of claim 6, wherein the intermediate lithium ion battery recycling material shows a particle size distribution, determined by laser light scattering, having a D(10) value in a range of from 2 to 6 μm, a D(50) value in a range of from 10 to 30 μm, and a D(90) value in a range of from 150 to 250 μm.

13. The process of claim 6, wherein the intermediate lithium ion battery recycling material has been obtained by mechanically comminuting at least one selected from the group consisting of a lithium ion battery, lithium ion battery waste, lithium ion battery production scrap, lithium ion cell production scrap, lithium ion cathode active material, and combinations thereof and subsequent drying of the comminuted material.

14. The process of claim 6, wherein the intermediate lithium ion battery recycling material comprises from 1 weight % to 5 weight % aluminum in a zero oxidation state as aluminum foil, and from 50 weight % to 95 weight % of cathode active material; wherein each weight % is by total weight of the intermediate lithium ion battery recycling material.

15. A method of using an aluminum composite material according to claim 1, the method comprising using the aluminum composite material recovering valuable materials from lithium ion batteries.
